(19) United States
(12) Patent Application Publication
(10) Pub. No.: US 2026/0333442 A1
(43) Pub. Date: Oct. 22, 2026

(54) METHOD AND APPARATUS OF BEAM DETERMINATION

(71) Applicant: LENOVO (BEIJING) LIMITED, Beijing (CN)

(72) Inventors: Wei Ling, Beijing (CN); Yi Zhang, Beijing (CN); Chenxi Zhu, Beijing (CN); Bingchao Liu, Beijing (CN); Lingling Xiao, Beijing (CN)

(21) Appl. No.: 19/110,366

(22) PCT Filed: Dec. 15, 2022
(86) PCT No.: PCT/CN2022/139396

§ 371 Date: Mar. 10, 2025

(51) Int. Cl. H04W 74/0833; H04B 7/06

(52) U.S. Cl. CPC H04W 74/0833; H04B 7/06968

(57) ABSTRACT

Embodiments of the present application are related to a method and apparatus of beam determination. An exemplary method includes: receiving a PRACH resource in a BWP of a serving cell; determining QCL properties of DMRS port of a PDCCH in response to the PRACH resource at least based on whether a plurality of values of CORESET pool index are configured for CORESETs in the BWP of the serving cell and a plurality of TAGs are configured in the serving cell, or whether L1/L2 based inter-cell mobility is configured in the serving cell; and transmitting the PDCCH based on the determined QCL properties of DMRS port of the PDCCH.

### TECHNICAL FIELD

Embodiments of the present application generally relate to wireless communication technology, especially to a method and an apparatus of beam determination, e.g., beam determination in scenarios of multi-downlink control information (DCI) (M-DCI) based multi-transmit-receive point (TRP) (M-TRP) or scenarios of layer 1 (L1)/layer 2 (L2)-triggered mobility (or L1/L2 triggered mobility or L1/L2 based mobility).

### BACKGROUND

It is known that inter-cell M-DCI based M-TRP is specified in release (R) 17 multiple-input multiple-output (MIMO) and it has been agreed that two-timing advance (TA) enhancement will be supported for inter-cell and intra-cell M-DCI based M-TRP in R18. For example, a MIMO related work item (WI) is approved in R18, wherein a topic concerning on multi-TRP/panel uplink (UL) transmission is to study, and if justified, specify: two TAs for UL M-DCI for multi-TRP operation. In addition, there is another WID, i.e., L1/L2-triggered mobility (or L1/L2 triggered mobility) in NR R18, which also includes the TA enhancement. Thus, TA enhancement for inter-cell case is studied in both R18 MIMO and R18 L1/L2-triggered mobility (or L1/L2 triggered mobility).

It is also known that TA acquisition is performed by a random access channel (RACH) procedure. A physical random access channel (PRACH) (or PRACH resource or preamble) will be transmitted to a TRP to obtain a TA for the TRP, or to a candidate cell to obtain a TA for the candidate cell. However, the mechanism of beam determination of physical downlink shared channel (PDSCH) and physical downlink control channel (PDCCH) related to a PRACH transmission (or related to a PRACH resource or the like) is not suitable for the TA enhancement either in scenarios of M-DCI based M-TRP or in scenarios of L1/L2-triggered mobility (or L1/L2 triggered mobility).

Given the above, the industry needs to study and solve the technical problems at least concerning determination of beams for PDCCH and PDSCH related to PRACH transmission considering the TA enhancement either in scenarios of M-DCI based M-TRP or in scenarios of L1/L2-triggered mobility (or L1/L2 triggered mobility).

### SUMMARY OF THE APPLICATION

One objective of the embodiments of the present application is to provide a technical solution of beam determination, e.g., a technical solution of beam determination for PDCCH order, PDCCH and PDSCH related to PRACH transmission, which can be applied in M-DCI based M-TRP scenarios and L1/L2-triggered mobility (or L1/L2 triggered mobility) scenarios with TA enhancement.

Some embodiments of the present application provide a wireless communication apparatus, e.g., a user equipment (UE), which includes: a transceiver; and a processor coupled to the transceiver, wherein the processor is configured to: transmit a PRACH resource in a bandwidth part (BWP) of a serving cell; determine quasi co-location (QCL) properties of demodulation reference signal (DMRS) port of a PDCCH in response to the PRACH resource at least based on whether a plurality of values of CORESET pool index are configured for CORESETs in the BWP of the serving cell and a plurality of timing advance groups (TAGs) are configured in the serving cell, or whether layer 1/layer 2 (L1/L2)-triggered mobility is configured in the serving cell; and receive the PDCCH based on the determined QCL properties of DMRS port of the PDCCH.

Some other embodiments of the present application provide a wireless communication method, e.g., a method performed by a UE, which includes: receiving a PRACH resource in a BWP of a serving cell; determining QCL properties of DMRS port of a PDCCH in response to the PRACH resource at least based on whether a plurality of values of CORESET pool index are configured for CORESETs in the BWP of the serving cell and a plurality of TAGs are configured in the serving cell, or whether L1/L2-triggered mobility is configured in the serving cell; and transmitting the PDCCH based on the determined QCL properties of DMRS port of the PDCCH.

In some embodiments of the present application, determining the QCL properties of DMRS port of the PDCCH includes: determining that the DMRS port of the PDCCH is QCL with at least one reference signal (RS) associated with a transmission configuration indication (TCI) state of a CORESET where the PDCCH is received in response to that: two values of CORESET pool index are configured for CORESETs in the BWP of the serving cell and two TAGs are configured in the serving cell; or L1/L2-triggered mobility is configured in the serving cell; or two values of CORESET pool index are configured for CORESETs in the BWP of the serving cell, two TAGs are configured in the serving cell, at least one activated joint or downlink TCI state is associated with an additional physical cell identifier (PCI) and the PRACH resource is associated with the additional PCI; or L1/L2-triggered mobility is configured in the serving cell and the PRACH resource is associated with an additional PCI or a candidate cell; or two values of CORESET pool index are configured for CORESETs in the BWP of the serving cell, two TAGs are configured in the serving cell, and the PRACH resource is associated with a value of CORESET pool index which is different from a value of CORESET pool index of a CORESET where the PDCCH is received; or two values of CORESET pool index are configured for CORESETs in the BWP of the serving cell, two TAGs are configured in the serving cell, at least one activated joint or downlink TCI state is associated with an additional PCI, only one type 1 common search space (CSS) associated with a CORESET which is associated with a PCI of the serving cell is configured, and the PRACH resource is associated with the additional PCI.

In some embodiments of the present application, determining the QCL properties of DMRS port of the PDCCH includes: determining that the DMRS port of the PDCCH is QCL with a synchronization signal (SS)/physical broadcast channel (PBCH) block (SSB) resource or channel state information (CSI)-RS resource used for transmitting the PRACH resource, in response to that: two values of CORESET pool index are configured for CORESETs in the BWP of the serving cell, two TAGs are configured in the serving cell, at least one activated joint or downlink TCI state is associated with an additional PCI and the PRACH resource is associated with a PCI of the serving cell; or L1/L2-triggered mobility is configured in the serving cell and the PRACH resource is associated with the PCI of the serving cell; or two values of CORESET pool index are configured for CORESETs in the BWP of the serving cell, two TAGs are configured in the serving cell, and the PRACH resource is associated with a value of CORESET pool index of a CORESET where the PDCCH is received; or two values of CORESET pool indexes in different CORESETs are configured for CORESETs in the BWP of the serving cell, two TAGs are configured in the serving cell, at least one activated joint or downlink TCI state is associated with an additional PCI and one additional type 1 CSS associated with a CORESET which is associated with the additional PCI is configured, or two values of CORESET pool indexes in different CORESETs are configured for CORESETs in the BWP of the serving cell, two TAGs are configured in the serving cell, at least one activated joint or downlink TCI state is associated with an additional PCI, only one type 1 CSS associated with a CORESET which is associated with a PCI of the serving cell is configured, and the PRACH resource is associated with the PCI of the serving cell.

In some embodiments of the present application, the processor is further configured to determine QCL properties of DMRS ports of a PDSCH scheduled by the PDCCH, including: determining the QCL properties of DMRS ports of the PDSCH based on whether a parameter as “dl-OrJoint-TCIStateList-r17” is configured, wherein: in the case that the parameter as “dl-OrJoint-TCIStateList-r17” is not configured, two values of CORESET pool index are configured for CORESETs in the BWP of the serving cell, and two TAGs are configured in the serving cell, determining that the DMRS ports of the PDSCH are QCL with: at least one RS associated with a TCI state of a CORESET where the PDCCH is received, in response to that a time offset between reception of the PDCCH and the PDSCH is equal to or greater than a threshold; or at least one RS associated with a TCI state of a CORESET associated with a monitored search space with a lowest CORESET identity among CORESETs which are configured with a same value of CORESET pool index of the PDCCH in a latest slot where one or more CORESETs associated with the same value of CORESET pool index are monitored in response to that the time offset between reception of the PDCCH and the PDSCH is less than the threshold, at least one configured TCI state for the serving cell of the PDSCH contains a parameter as “qcl-Type” set to ‘typeD’ and a parameter as “enableDefaultTCI-StatePerCoresetPoolIndex” is configured; or in the case that the parameter as “dl-OrJoint-TCIStateList-r17” is configured, two values of CORESET pool index are configured for CORESETs in the BWP of the serving cell, and two TAGs are configured in the serving cell, determining that the DMRS ports of the PDSCH are QCL with: at least one RS associated with a joint or downlink TCI state which is applicable in a slot where the PDSCH is received and associated with a same CORESET pool index of a CORESET where the PDCCH is received; or in the case that the parameter “dl-OrJoint-TCIStateList-r17” is configured, and L1/L2-triggered mobility is configured in the serving cell, determining that the DMRS ports of the PDSCH are QCL with: at least one RS associated with a joint or downlink TCI state which is applicable in a slot where the PDSCH is received.

According to some embodiments of the present application, the processor is configured to determine the QCL properties of DMRS ports of the PDSCH based on whether a parameter as “dl-OrJoint-TCIStateList-r17” is configured in the case that: two values of CORESET pool index are configured for CORESETs in the BWP of the serving cell, two TAGs are configured in the serving cell, at least one activated joint or downlink TCI state is associated with an additional PCI and the PRACH resource is associated with the additional PCI; or two values of CORESET pool index are configured for CORESETs in the BWP of the serving cell, two TAGs are configured in the serving cell, and the PRACH resource is associated with a value of CORESET pool index different from that of a CORESET where the PDCCH is received; or L1/L2-triggered mobility is configured in the serving cell and the PRACH resource is associated with an additional PCI or a candidate cell; or two values of CORESET pool index are configured for CORESETs in the BWP of the serving cell, two TAGs are configured in the serving cell, at least one activated joint or downlink TCI state is associated with an additional PCI, only one type 1 CSS associated with a CORESET which is associated with a PCI of the serving cell is configured, and the PRACH resource is associated with the additional PCI.

In some embodiments of the present application, the processor is further configured to determine QCL properties of DMRS ports of a PDSCH scheduled by the PDCCH, including: determining that the DMRS ports of the PDSCH is QCL with an SSB resource or CSI-RS resource used for transmitting the PRACH resource, in response to that: two values of CORESET pool index are configured for CORESETs in the BWP of the serving cell, two TAGs are configured in the serving cell, at least one activated joint or downlink TCI state is associated with an additional PCI, and the PRACH resource is associated with a PCI of the serving cell; or two values of CORESET pool index are configured for CORESETs in the BWP of the serving cell, two TAGs are configured in the serving cell, and the PRACH resource is associated with a value of CORESET pool index of a CORESET where the PDCCH is received; or L1/L2-triggered mobility is configured in the serving cell and the PRACH resource is associated with a PCI of the serving cell; or two values of CORESET pool index are configured for CORESETs in the BWP of the serving cell, two TAGs are configured in the serving cell, at least one activated joint or downlink TCI state is associated with an additional PCI, and an additional type 1 CSS associated with a CORESET which is associated with the additional PCI is configured; or two CORESET pool indexes configured or CORESETs in the BWP of the serving cell, two TAGs are configured in the serving cell, at least one activated joint or downlink TCI state is associated with an additional PCI, only one type 1 CSS associated with a CORESET which is associated with a PCI of the serving cell is configured, and transmission of the PRACH resource is associated with the PCI of the serving cell.

In some embodiments of the present application, transmission of the PRACH resource is initiated by a PDCCH order and the processor is further configured to determine QCL properties of DMRS port of the PDCCH order, including: determining that the DMRS port of the PDCCH order is QCL with at least one RS of a TCI state of a CORESET where the PDCCH order is transmitted in response to that two values of CORESET pool index are configured for CORESETs in the BWP of the serving cell, and two TAGs are configured in the serving cell; or L1/L2-triggered mobility is configured in the serving cell; or L1/L2-triggered mobility is configured in the serving cell and the PRACH resource is associated with an additional PCI or a candidate cell; or determining that the DMRS port of the PDCCH order is QCL with an SSB resource or CSI-RS resource used for transmitting the PRACH resource in response to that L1/L2-triggered mobility is configured in the serving cell and the PRACH resource is associated with a PCI of the serving cell.

Some other embodiments of the present application provide another wireless communication apparatus, e.g., a radio access network (RAN) node, which includes: a transceiver; and a processor coupled to the transceiver, wherein the processor is configured to: receive a PRACH resource in a BWP of a serving cell; determine QCL properties of DMRS port of a PDCCH in response to the PRACH resource at least based on whether a plurality of values of CORESET pool index are configured for CORESETs in the BWP of the serving cell and a plurality of TAGs are configured in the serving cell, or whether L1/L2-triggered mobility is configured in the serving cell; and transmit the PDCCH based on the determined QCL properties of DMRS port of the PDCCH.

In some embodiments of the present application, determining the QCL properties of DMRS port of the PDCCH includes: determining that the DMRS port of the PDCCH is QCL with at least one RS associated with a TCI state of a CORESET where the PDCCH is transmitted in response to that: two values of CORESET pool index are configured for CORESETs in the BWP of the serving cell and two TAGs are configured in the serving cell; or L1/L2-triggered mobility is configured in the serving cell; or two values of CORESET pool index are configured for CORESETs in the BWP of the serving cell, two TAGs are configured in the serving cell, at least one activated joint or downlink TCI state is associated with an additional PCI and the PRACH resource is associated with the additional PCI; or L1/L2-triggered mobility is configured in the serving cell and the PRACH resource is associated with an additional PCI or a candidate cell; or two values of CORESET pool index are configured for CORESETs in the BWP of the serving cell, two TAGs are configured in the serving cell, and the PRACH resource is associated with a value of CORESET pool index which is different from a value of CORESET pool index of a CORESET where the PDCCH is transmitted; or two values of CORESET pool index are configured for CORESETs in the BWP of the serving cell, two TAGs are configured in the serving cell, at least one activated joint or downlink TCI state is associated with an additional PCI, only one type 1 CSS associated with a CORESET which is associated with a PCI of the serving cell is configured and the PRACH resource is associated with the additional PCI.

In some embodiments of the present application, determining the QCL properties of DMRS port of the PDCCH includes: determining that the DMRS port of the PDCCH is QCL with an SSB resource or CSI-RS resource used for receiving the PRACH resource, in response to that: two values of CORESET pool index are configured for CORESETs in the BWP of the serving cell, two TAGs are configured in the serving cell, at least one activated joint or downlink TCI state is associated with an additional PCI and the PRACH resource is associated with a PCI of the serving cell; or L1/L2-triggered mobility is configured in the serving cell and the PRACH resource is associated with the PCI of the serving cell; or two values of CORESET pool index are configured for CORESETs in the BWP of the serving cell, two TAGs are configured in the serving cell, and the PRACH resource is associated with a value of CORESET pool index of a CORESET where the PDCCH is transmitted; or two values of CORESET pool indexes in different CORESETs are configured for CORESETs in the BWP of the serving cell, two TAGs are configured in the serving cell, at least one activated joint or downlink TCI state is associated with an additional PCI and one additional type 1 CSS associated with a CORESET which is associated with the additional PCI is configured, or two values of CORESET pool indexes in different CORESETs are configured for CORESETs in the BWP of the serving cell, two TAGs are configured in the serving cell, at least one activated joint or downlink TCI state is associated with an additional PCI, only one type 1 CSS associated with a CORESET which is associated with a PCI of the serving cell is configured and the PRACH resource is associated with the PCI of the serving cell.

According to some embodiments of the present application, the processor is further configured to determine QCL properties of DMRS ports of a PDSCH scheduled by the PDCCH, including: determining the QCL properties of DMRS ports of the PDSCH based on whether a parameter as “dl-OrJoint-TCIStateList-r17” is configured, wherein: in the case that the parameter as “dl-OrJoint-TCIStateList-r17” is not configured, two values of CORESET pool index are configured for CORESETs in the BWP of the serving cell, and two TAGs are configured in the serving cell, determining that the DMRS ports of the PDSCH are QCL with: at least one RS associated with a TCI state of a CORESET where the PDCCH is transmitted, in response to that a time offset between transmission of the PDCCH and the PDSCH is equal to or greater than a threshold; or at least one RS associated with a TCI state of a CORESET associated with a monitored search space with a lowest CORESET identity among CORESETs which are configured with a same value of CORESET pool index of the PDCCH in a latest slot where one or more CORESETs associated with the same value of CORESET pool index are monitored in response to that the time offset between transmission of the PDCCH and the PDSCH is less than the threshold, at least one configured TCI state for the serving cell of the PDSCH contains a parameter as “qcl-Type” set to ‘typeD’ and a parameter as “enableDefaultTCI-StatePerCoresetPoolIndex” is configured; or in the case that the parameter as “dl-OrJoint-TCIStateList-r17” is configured, two values of CORESET pool index are configured for CORESETs in the BWP of the serving cell, and two TAGs are configured in the serving cell, determining that the DMRS ports of the PDSCH is QCL with: at least one RS associated with a joint or downlink TCI state which is applicable in a slot where the PDSCH is transmitted and associated with a same CORESET pool index of a CORESET where the PDCCH is transmitted; or in the case that the parameter as “dl-OrJoint-TCIStateList-r17” is configured, and L1/L2-triggered mobility is configured in the serving cell, determining that the DMRS ports of the PDSCH are QCL with: at least one RS associated with a joint or downlink TCI state which is applicable in a slot where the PDSCH is transmitted.

According to some embodiments of the present application, the processor is configured to determine the QCL properties of DMRS ports of the PDSCH based on whether a parameter as “dl-OrJoint-TCIStateList-r17” is configured in the case that: two values of CORESET pool index are configured for CORESETs in the BWP of the serving cell, two TAGs are configured in the serving cell, at least one activated joint or downlink TCI state is associated with an additional PCI and the PRACH resource is associated with the additional PCI; or two values of CORESET pool index are configured for CORESETs in the BWP of the serving cell, two TAGs are configured in the serving cell, and the PRACH resource is associated with a value of CORESET pool index different from that of a CORESET where the PDCCH is transmitted; or L1/L2-triggered mobility is configured in the serving cell and the PRACH resource is associated with an additional PCI or a candidate cell; or two values of CORESET pool index are configured for CORESETs in the BWP of the serving cell, two TAGs are configured in the serving cell, at least one activated joint or downlink TCI state is associated with an additional PCI, only one type 1 CSS associated with a CORESET which is associated with a PCI of the serving cell is configured, and the PRACH resource is associated with the additional PCI.

In some embodiments of the present application, the processor is further configured to determine QCL properties of DMRS ports of a PDSCH scheduled by the PDCCH, including: determining that the DMRS ports of the PDSCH is QCL with an SSB resource or CSI-RS resource used for receiving the PRACH resource, in response to that: two values of CORESET pool index are configured for CORESETs in the BWP of the serving cell, two TAGs are configured in the serving cell, at least one activated joint or downlink TCI state is associated with an additional PCI, and the PRACH resource is associated with a PCI of the serving cell; two values of CORESET pool index are configured for CORESETs in the BWP of the serving cell, two TAGs are configured in the serving cell, and the PRACH resource is associated with a value of CORESET pool index of a CORESET where the PDCCH is transmitted; or L1/L2-triggered mobility is configured in the serving cell and the PRACH resource is associated with a PCI of the serving cell; or two values of CORESET pool index are configured for CORESETs in the BWP of the serving cell, two TAGs are configured in the serving cell, at least one activated joint or downlink TCI state is associated with an additional PCI, and an additional type 1 CSS associated with a CORESET which is associated with the additional PCI is configured; or two CORESET pool indexes configured or CORESETs in the BWP of the serving cell, two TAGs are configured in the serving cell, at least one activated joint or downlink TCI state is associated with an additional PCI, only one type 1 CSS associated with a CORESET which is associated with a PCI of the serving cell is configured, and transmission of the PRACH resource is associated with the PCI of the serving cell.

In some embodiments of the present application, transmission of the PRACH resource is initiated by a PDCCH order and the processor is further configured to determine QCL properties of DMRS port of the PDCCH order, including: determining that the DMRS port of the PDCCH order is QCL with at least one RS of a TCI state of a CORESET where the PDCCH order is transmitted in response to that two values of CORESET pool index are configured for CORESETs in the BWP of the serving cell, and two TAGs are configured in the serving cell; or L1/L2-triggered mobility is configured in the serving cell; or L1/L2-triggered mobility is configured in the serving cell and the PRACH resource is associated with an additional PCI or a candidate cell; or determining that the DMRS port of the PDCCH order is QCL with an SSB resource or CSI-RS resource used for receiving the PRACH resource in response to that L1/L2-triggered mobility is configured in the serving cell and the PRACH resource is associated with a PCI of the serving cell.

Given the above, embodiments of the present application provide a technical solution of beam determination, solving beam determination issues in multi-DCI based multi-TRP scenarios and L1/L2-triggered mobility scenarios with TA enhancement, and thus can facilitate and improve the implementation of NR.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to an embodiment of the present application.

FIG. 2 is a schematic diagram illustrating a RACH procedure for TA acquisition according to some embodiments of the present application.

FIG. 3 illustrates a flow chart of a method of beam determination according to some embodiments of the present application.

FIG. 4 illustrates a block diagram of an apparatus of beam determination according to some embodiments of the present application.

FIG. 5 illustrates a block diagram of an apparatus of beam determination according to some other embodiments of the present application.

### DETAILED DESCRIPTION

The detailed description of the appended drawings is intended as a description of preferred embodiments of the present application, and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP long term evolution (LTE), and so on. It is contemplated that along with the developments of network architectures and new service scenarios, all embodiments in the present application are also applicable to similar technical problems; and moreover, the terminologies recited in the present application may change, which should not affect the principle of the present application.

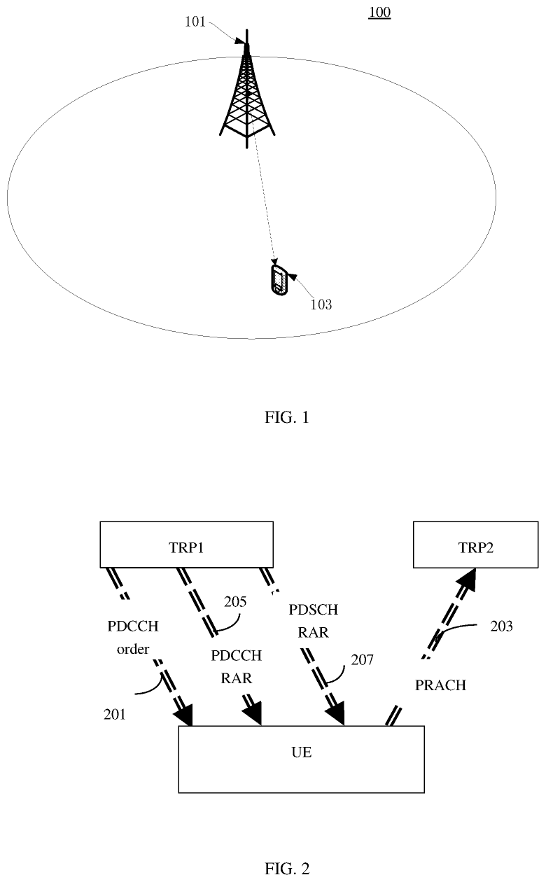

FIG. 1 illustrates a schematic diagram of an exemplary wireless communication system 100 according to some embodiments of the present application.

As shown in FIG. 1, the wireless communication system 100 includes a UE 103 and a base station (BS) 101. Although merely one BS is illustrated in FIG. 1 for simplicity, it is contemplated that the wireless communication system 100 may include more BSs in some other embodiments of the present application. Similarly, although merely one UE is illustrated in FIG. 1 for simplicity, it is contemplated that the wireless communication system 100 may include more UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

In addition, a BS 101 may be configured with one transmit-receive point (TRP) (or panel), i.e., in a single-TRP scenario or more TRPs (or panels), i.e., a multi-TRP scenario. That is, one or more TRPs are associated with the BS 101. A TRP can act like a small BS. Two TRPs can have the same cell ID (identity or index) or different cell IDs. Two TRPs can communicate with each other by a backhaul link. Such a backhaul link may be an ideal backhaul link or a non-ideal backhaul link. Latency of the ideal backhaul link may be deemed as zero, and latency of the non-ideal backhaul link may be tens of milliseconds and much larger, e.g. on the order of tens of milliseconds, than that of the ideal backhaul link.

A single TRP can be used to serve one or more UE 103 under the control of a BS 101. In different scenarios, a TRP may be referred to as different terms, which may be represented by a TCI state index or CORESETPoolIndex value etc. It should be understood that the TRP(s) (or panel(s)) configured for the BS 101 may be transparent to a UE 103.

The UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 103 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present application, the UE 103 may include wearable devices, such as smart watches, fitness bands, optical head-mounted displays, or the like. Moreover, the UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE 103 may move among different cells. Conventionally, serving cell change is performed by explicit radio resource control (RRC) reconfiguration signaling to trigger the synchronization of target cell based on layer 3 (L3) measurements report. In 3GPP R18, a new work item on further NR mobility enhancements is approved to enable a serving cell change via lower layer signaling, e.g., L1 or L2 signaling, in order to reduce the latency, overhead and interruption time.

In both R18 MIMO and R18 L1/L2-triggered mobility, TA enhancement for inter-cell cases is studied. However, the current mechanism of beam determination for PDCCH and PDCCH related to TA acquisition performed by a RACH procedure is not suitable for M-DCI based M-TRP and L1/L2-triggered mobility supporting TA enhancement, e.g., 2-TA enhancement.

FIG. 2 is a schematic diagram illustrating a RACH procedure for TA acquisition according to some embodiments of the present application.

According to legacy specification, the beam (represent by a RS, e.g., CSI-RS or SSB, or spatial relationship filter, TCI state or QCL properties of DMRS port etc.) for a PDSCH and PDCCH related to a PRACH transmission is always as the same as the beam used for the PRACH transmission. The PDCCH related to a PRACH transmission is also referred to as a PDCCH carrying random access response (RAR) or a PDCCH RAR etc. ; and the PDSCH related to a PRACH transmission is also referred to as a PDSCH carrying RAR or a PDSCH RAR etc.

In addition, according to the legacy specification, if the RACH procedure is contention free random access (CFRA) triggered by a PDCCH order for special cell (SpCell), then the beam for the PDCCH order, the PDCCH RAR and the PDSCH RAR are the same as the beam for the PRACH. According to an agreement in AI 9.1.1.2 of RAN1 #111, in scenarios of M-DCI based M-TRP, the PDCCH order from one TRP can trigger a CFRA towards another TRP in inter-cell M-DCI based M-TRP scenarios.

As shown in FIG. 2, during a RACH procedure to obtain TA, e.g., during CFRA triggered by PDCCH order for SpCell, the UE will transmit a PRACH (PRACH resource or preamble etc.) in step 203, which is initiated or triggered by a PDCCH order received from the network side in step 201. Then, the UE will receive the PDCCH RAR associated with the PRACH in step 205, and then receive the PDSCH RAR scheduled by the PDCCH RAR in step 207.

In scenarios of M-DCI based M-TRP, the PDCCH RAR and its scheduled PDSCH RAR are always transmitted from the same TRP, e.g., TRP1 (or TRP2), while PDCCH RAR is transmitted in type 1 CSS which is transmitted from only one TRP, e.g., TRP1. It is assumed that the UE will transmit a PRACH to TRP2 in step 203, which is initiated by the PDCCH order received from TRP1 in step 201. If the PDCCH RAR is received from TRP1 by the UE in step 205, then the PDSCH RAR will also be received from TRP1 by the UE in step 207, which cannot use the beam of PRACH towards TRP2.

In addition, since the PDCCH order from one TRP, e.g., TRP1 can trigger a CFRA towards another TRP, e.g., TRP2 in inter-cell M-DCI based M-TRP scenarios, the beam of the PDCCH order cannot always be the same as the beam of the triggered PRACH. As stated above, the PDCCH RAR is always transmitted from type 1 CSS which can only be transmitted from one TRP. Thus, the beam of the PDCCH RAR cannot always be the same as the beam of the PRACH because the PRACH can be transmitted to the other TRP to obtain the TA of the other TRP. Accordingly, the beam determination of PDCCH order and PDCCH RAR should also be enhanced for TA enhancement in M-DCI based M-TRP scenarios.

Regarding the scenarios of L1/L2-triggered mobility (where it is assumed that TA enhancement will be always supported), since the PDCCH RAR and PDSCH RAR can only be transmitted from the serving cell while the PRACH should be transmitted to a candidate cell to obtain a TA for the candidate cell, the issues similar to the above analyzed in scenarios of M-DCI based M-TRP also exist.

At least for solving the above technical problems, embodiments of the present application provide a technical solution of beam determination, e.g., a method and apparatus of beam determination in M-DCI based M-TRP scenarios supporting TA enhancement and L1/L2-triggered mobility scenarios supporting TA enhancement.

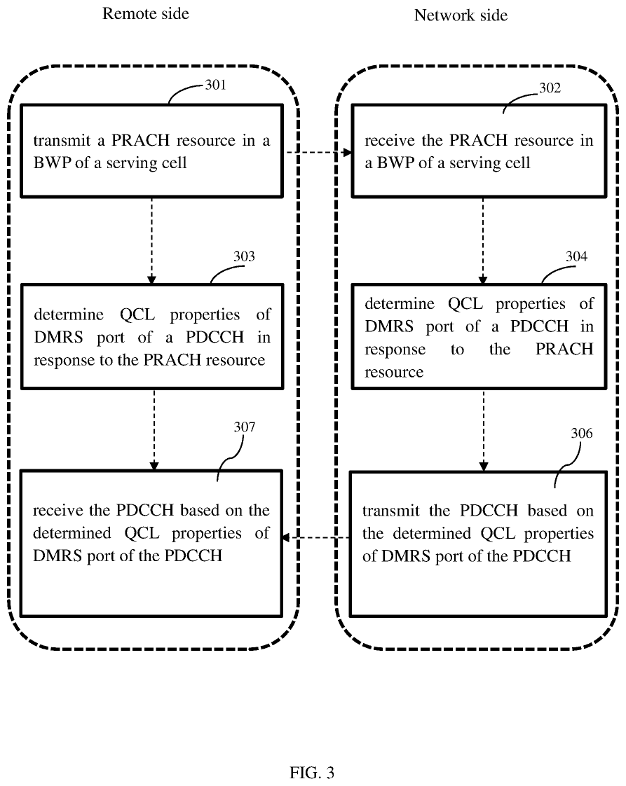

FIG. 3 illustrates a flow chart of a method of beam determination according to some embodiments of the present application. Although the method is illustrated in a system level by a UE in a remote side (or UE side) and a BS in a network side (or BS side), persons skilled in the art can understand that the method implemented in the remote side and that implemented in the network side can be separately implemented and incorporated by other apparatus with similar functions. In addition, no transmission or reception failure is considered in the illustrated embodiments of the present application.

As shown in FIG. 3, in step 301, a wireless communication apparatus in the remote side, e.g., a UE may transmit a PRACH resource in a BWP of a serving cell. For example, transmission of the PRACH resource (or transmission of the PRACH) is initiated by a PDCCH order from the network side, so that a CFRA is triggered by the PDCCH order for SpCell. In some other embodiments of the present application, transmission of the PRACH resource is triggered or initiated for contention based random access (CBRA). Accordingly, the network side, e.g., a gNB will receive the PRACH resource in the BWP of the serving cell in step 302.

In step 303, the remote side, e.g., the UE will determine beam(s) for a PDCCH in response to the PRACH (e.g., PDCCH RAR) at least based on whether the UE is configured in M-DCI based M-TRP with TA enhancement or whether the UE is configured in L1/L2-triggered mobility. The beam(s) for the PDCCH can be represented by QCL properties of DMRS port of the PDCCH or other manners. Similar determination will be performed in the network side, e.g., by a gNB in step 304.

There are various manners for determining whether the UE is configured in M-DCI based M-TRP with TA enhancement or whether the UE is configured in L1/L2-triggered mobility. For example, whether a plurality of values of CORESET pool index (e.g., CORESETPoolIndex values, each corresponding to a TRP) are configured for CORESETs in the BWP of the serving cell and a plurality of TAGs are configured in the serving cell will be determined, to determine whether the UE is configured in M-DCI based M-TRP with TA enhancement. In another example, whether L1/L2-triggered mobility is configured in the serving cell will be determined, to determine whether the UE is configured in L1/L2-triggered mobility.

Based on the determined beam, e.g., the determined QCL properties of DMRS port of the PDCCH, the network side, e.g., the gNB will transmit the PDCCH in step 306. Accordingly, based on the determined beam, e.g., the determined QCL properties of DMRS port of the PDCCH, the remote side, e.g., the UE will receive the PDCCH in step 307. The PDCCH schedules a PDSCH associated with the PRACH (e.g., PDSCH RAR).

In some embodiments of the present application, beam for the PDSCH scheduled by the PDCCH (e.g., PDSCH RAR), e.g., the QCL properties of DMRS port of the PDSCH will also be determined at least based on whether the UE is configured in M-DCI based M-TRP with TA enhancement or whether the UE is configured in L1/L2-triggered mobility. The PDSCH will be transmitted from the network side to the remote side with the determined beam for the PDSCH, e.g., based on the QCL properties of DMRS ports of the PDSCH.

In some scenarios, e.g., in CFRA triggered by a PDCCH order for SpCell, transmission of the PRACH resource is initiated by a PDCCH order. According to some embodiments of the present application, beam for the PDCCH order initiating (or triggering) the transmission of the PRACH resource, e.g., the QCL properties of DMRS port of the PDCCH order will also be determined at least based on whether the UE is configured in M-DCI based M-TRP with TA enhancement or whether the UE is configured in L1/L2-triggered mobility. The PDCCH order will be transmitted from the network side to the remote side with the determined beam, e.g., based on the QCL properties of DMRS port of the PDCCH order.

More detailed embodiments of the present application will be illustrated in the following in view of the PDCCH, PDSCH and PDCCH order respectively. Since the technical solutions of the present application mainly focus on the beam determination in M-DCI based M-TRP scenarios with TA enhancement and L1/L2-triggered mobility scenarios, herein, it is always assumed that the UE is in M-DCI based M-TRP scenarios with TA enhancement and L1/L2-triggered mobility scenarios. One or more signalling, e.g., RRC signalling, will be used to indicate whether a UE is configured with M-DCI based M-TRP supporting TA enhancement or is configured with L1/L2-triggered mobility for TA acquisition of a candidate cell (or an additional PCI). The M-DCI based M-TRP (or M-DCI based M-TRP scenarios) may be inter-cell M-DCI based M-TRP or intra-cell M-DCI based M-TRP. For example, if two different CORESETPoolIndex values are configured in a BWP of a serving cell and 2 TAGs are configured in the serving cell, it will be identified as in M-DCI based M-TRP supporting 2-TA enhancement. If a configuration or a parameter, e.g., a RRC parameter (e.g., “L1/L2Mobility” or the like) which means L1/L2-triggered mobility is configured in a serving cell, is configured in a serving cell, it will be identified as L1/L2-triggered mobility.

Persons skilled in the art should well know that although some configurations and/or parameters, e.g., “dl-OrJoint-TCIStateList-r17,” and “PDCCH-Config” etc. are common known in legacy specifications, they may evolve into other terms as the evolution of 3GPPP. Thus, the name of such configurations and/or parameters should not be used to unduly limit the scope of the present application, and should be reasonably interpreted with their technical substance. In addition, although some embodiments are illustrated in view of only one side, e.g., the network side or the remote side, persons skilled in the art would clearly determine how to consistently apply the technical solutions in the other side based on the consistency between the network side and remote side.

### Beam Determination for PDCCH

According to some embodiments of the present application, PDCCH in response to PRACH resource, e.g., PDCCH RAR is PDCCH (DCI format 1_0) with cyclic redundancy check (CRC) scrambled by random access (RA) radio network temporary identifier (RNTI) (RA-RNTI) or MSGB-RNTI. In other words, an exemplary PDCCH is PDCCH with DCI format 1_0 and CRC scrambled by RA-RNTI in response to a PRACH transmission initiated by a PDCCH order that triggers a CFRA procedure for the SpCell, or PDCCH with DCI format 1_0 and CRC scrambled by MSGB-RNTI.

Regarding the beam determination of the PDCCH, in some embodiments of the present application, the beam of the PDCCH is always the same as the beam of the CORESET where the PDCCH is transmitted (or the CORESET associated with the type 1 CSS set where the PDCCH is transmitted) (or the CORESET where the PDCCH is received for the remote side). The type 1 CSS set where the PDCCH is transmitted or received is also referred to as type 1 PDCCH CSS set which is configured to be associated with a CORESET. In some other embodiments of the present application, the beam of the PDCCH is the same as the beam of the CORESET where the PDCCH is transmitted in some conditions, while is the same as the beam used for the PRACH transmission in some other conditions, e.g., as the same as the SSB resource or CSI-RS resource used for the PRACH transmission.

For example, in some embodiments of the present application, determining the QCL properties of DMRS port of the PDCCH in step 203 (similar in step 204) includes: determining that the DMRS port of the PDCCH is QCL with at least one RS associated with a TCI state of a CORESET where the PDCCH is received (or a CORESET where the PDCCH is transmitted in step 204) in response to that:
a) two values of CORESET pool index are configured for CORESETs in the BWP of the serving cell and two TAGs are configured in the serving cell; or
b) L1/L2-triggered mobility is configured in the serving cell; or
c) two values of CORESET pool index are configured for CORESETs in the BWP of the serving cell, two TAGs are configured in the serving cell, at least one activated joint or downlink TCI state is associated with an additional PCI and the PRACH resource is associated with the additional PCI; or
d) L1/L2-triggered mobility is configured in the serving cell and the PRACH resource is associated with an additional PCI or a candidate cell; or
e) two values of CORESET pool index are configured for CORESETs in the BWP of the serving cell, two TAGs are configured in the serving cell, and the PRACH resource is associated with a value of CORESET pool index which is different from a value of CORESET pool index of a CORESET where the PDCCH is received; or
f) two values of CORESET pool index are configured for CORESETs in the BWP of the serving cell, two TAGs are configured in the serving cell, at least one activated joint or downlink TCI state is associated with an additional PCI, only one type 1 CSS associated with a CORESET which is associated with a PCI of the serving cell is configured and the PRACH resource is associated with the additional PCI.
In some other embodiments of the present application, determining the QCL properties of DMRS port of the PDCCH in step 203 (similar in step 204) includes: determining that the DMRS port of the PDCCH is QCL with an SSB resource or CSI-RS resource used for transmitting the PRACH resource, in response to that:
a) two values of CORESET pool index are configured for CORESETs in the BWP of the serving cell, two TAGs are configured in the serving cell, at least one activated joint or downlink TCI state is associated with an additional PCI and the PRACH resource is associated with a PCI of the serving cell; or
b) L1/L2-triggered mobility is configured in the serving cell and the PRACH resource is associated with the PCI of the serving cell; or
c) two values of CORESET pool index are configured for CORESETs in the BWP of the serving cell, two TAGs are configured in the serving cell, and the PRACH resource is associated with a value of CORESET pool index of a CORESET where the PDCCH is received; or
d) two values of CORESET pool indexes in different CORESETs are configured for CORESETs in the BWP of the serving cell, two TAGs are configured in the serving cell, at least one activated joint or downlink TCI state is associated with an additional PCI and one additional type 1 CSS associated with a CORESET which is associated with the additional PCI is configured, or
e) two values of CORESET pool indexes in different CORESETs are configured for CORESETs in the BWP of the serving cell, two TAGs are configured in the serving cell, at least one activated joint or downlink TCI state is associated with an additional PCI, only one type 1 CSS associated with a CORESET which is associated with a PCI of the serving cell is configured and the PRACH resource is associated with the PCI of the serving cell.

Some exemplary cases are illustrated below.

### Cases 1-1

According to some embodiments of the present application, regardless of M-DCI based M-TRP with TA enhancement or L1/L2-triggered mobility scenarios, the beam of the PDCCH will be always the same as the beam of the CORESET where the PDCCH is transmitted (or received). That is, the UE may assume the DMRS antenna port QCL properties of the CORESET associated with the type1 PDCCH CSS set for receiving the PDCCH, or the UE may assume the QCL properties of DMRS antenna port of the CORESET associated with the type1 PDCCH CSS set will be used for receiving the PDCCH.

### Cases 1-2

In some other embodiments of the present application, the beam of the PDCCH will be the same as the beam of the CORESET where the PDCCH is transmitted (or received) or is the same as the beam used for PRACH transmission, which depends on different specific configurations of the UE.

For example, in some exemplary scenarios of inter-cell M-DCI based M-TRP with TA enhancement or L1/L2-triggered mobility, e.g., in the case that the UE is configured by higher layer parameter “PDCCH-Config” that contains two different values of “coresetPoolIndex” in “ControlResourceSets” for the BWP of the serving cell and at least one activated joint or downlink TCI state is associated with an additional PCI, or if the UE is configured with L1/L2-triggered mobility, the beam of the PDCCH will be determined as the following. In the case that the corresponding PRACH transmission is associated with the serving cell PCI, the beam of the PDCCH will be determined as the same as the beam used for PRACH transmission. It means that the UE may assume that the DMRS port of the PDCCH is quasi co-located with the SSB resource or the CSI-RS resource that the UE used for the PRACH transmission as applicable, and transmission with respect to Doppler shift, Doppler spread, average delay, delay spread, spatial receiving (RX) parameters when applicable. Otherwise, in the case that the corresponding PRACH transmission is associated with the additional PCI, the beam of the PDCCH will be determined as the same as the beam of the CORESET associated with the type 1 CSS set where the PDCCH is transmitted (or received).

In some exemplary scenarios of intra-cell M-DCI based M-TRP, e.g., in the case that the UE is configured by higher layer parameter “PDCCH-Config” that contains two different values of “coresetPoolIndex” in “ControlResourceSets” for a BWP of the serving cell, the beam of the PDCCH will be determined as the following. In the case that the corresponding PRACH transmission is associated with the same CORESETPoolIndex value of a CORESET where the PDCCH is transmitted (or received), the beam of the PDCCH will be as the same as the beam used for the PRACH transmission. It means that the UE may assume that the DMRS port of the PDCCH is quasi co-located with the SSB resource or the CSI-RS resource that the UE used for the PRACH transmission as applicable, and transmission with respect to Doppler shift, Doppler spread, average delay, delay spread, spatial RX parameters when applicable. Otherwise, the beam of the PDCCH will be determined as the same as the beam of the CORESET associated with the type1 CSS set where the PDCCH is transmitted (or received).

### Cases 1-3

Similar to Cases 1-2, in some other embodiments of the present application, the beam of the PDCCH is the same as the beam of the CORESET where the PDCCH is transmitted or is the same as the beam used for PRACH transmission, which depends on different specific configurations of the UE. However, Cases 1-3 are only applied in inter-cell M-DCI based M-TRP.

For example, in some exemplary scenarios of inter-cell M-DCI based M-TRP, e.g., the UE is configured by higher layer parameter “PDCCH-Config” that contains two different values of “coresetPoolIndex” in “ControlResourceSets” for the BWP of the serving cell, and at least one activated joint or downlink TCI state is associated with an additional PCI, the beam of the PDCCH will be determined as the following.

In the case that an additional type 1 CSS associated with a CORESET which is associated with the additional PCI is configured, the beam of the PDCCH will be as the same as the beam used for the PRACH transmission. It means that the UE may assume that the DMRS port of the PDCCH is quasi co-located with the SSB source or the CSI-RS resource that the UE used for the PRACH transmission as applicable, and transmission with respect to Doppler shift, Doppler spread, average delay, delay spread, spatial RX parameters when applicable.

Otherwise, in the case that only one type 1 CSS associated with a CORESET which is associated with a PCI of the serving cell is configured and the PRACH resource is associated with the PCI of the serving cell, the beam of the PDCCH will be as the same as the beam used for the PRACH transmission. In the case that only one type 1 CSS associated with a CORESET which is associated with a PCI of the serving cell is configured, the beam of the PDCCH will be determined as the same as the beam of the CORESET where the PDCCH is transmitted (or received).

### Beam Determination for PDSCH

According to some embodiments of the present application, PDSCH scheduled by PDCCH in response to PRACH resource is PDSCH scheduled with RA-RNTI or MSGB-RNTI scheduled by DCI format 1_0 (or PDCCH with DCI format 1_0) with CRC scrambled by RA-RNTI or MSGB-RNTI. Therefore, there is no TCI field in the DCI in the PDCCH scheduling the PDSCH (also referred to as scheduling DCI).

Regarding the beam determination of the PDSCH, in some embodiments of the present application, the beam of the PDSCH is always determined based on whether the UE is configured with “dl-OrJoint-TCIStateList-r17.” In the case that the UE is not configured with “dl-OrJoint-TCIStateList-r17”, which implies unified framework is not applied for the UE, the beam of the PDSCH will be determined as R15 and R16 specification. In the case that the UE is configured with “dl-OrJoint-TCIStateList-r17,” which implies unified framework is applied for the UE, the beam of the PDSCH will be determined as R17 specification.

For example, in some embodiments of the present application, determining QCL properties of DMRS ports of a PDSCH scheduled by the PDCCH includes: determining the QCL properties of DMRS ports of the PDSCH based on whether a parameter as “dl-OrJoint-TCIStateList-r17” is configured.

In the case that the parameter as “dl-OrJoint-TCIStateList-r17” is not configured, two values of CORESET pool index are configured for CORESETs in the BWP of the serving cell, and two TAGs are configured in the serving cell, the DMRS ports of the PDSCH will be determined, e.g., by the UE to be QCL with:
a) at least one RS associated with a TCI state of a CORESET where the PDCCH is transmitted or received, in response to that a time offset between reception of the PDCCH and the PDSCH is equal to or greater than a threshold; or
b) at least one RS associated with a TCI state of a CORESET associated with a monitored search space with a lowest CORESET identity among CORESETs which are configured with a same value of CORESET pool index of the PDCCH in a latest slot where one or more CORESETs associated with the same value of CORESET pool index are monitored in response to that the time offset between reception of the PDCCH and the PDSCH is less than the threshold, at least one configured TCI state for the serving cell of the PDSCH contains a parameter as “qcl-Type” set to ‘typeD’ and a parameter as “enableDefaultTCI-StatePerCoresetPoolIndex” is configured.
In the case that the parameter as “dl-OrJoint-TCIStateList-r17” is configured and in exemplary scenarios of M-DCI based M-TRP with TA enhancement, e.g., two values of CORESET pool index are configured for CORESETs in the BWP of the serving cell, and two TAGs are configured in the serving cell, the DMRS ports of the PDSCH will be determined, e.g., by the UE to be QCL with: at least one RS associated with a joint or downlink TCI state which is applicable in a slot where the PDSCH is received and associated with a same CORESET pool index of a CORESET where the PDCCH is received.

In the case that the parameter “dl-OrJoint-TCIStateList-r17” is configured and L1/L2-triggered mobility is configured in the serving cell, the DMRS ports of the PDSCH will be determined, e.g., by the UE to be QCL with at least one RS associated with a joint or downlink TCI state which is applicable in a slot where the PDSCH is received.

In some other embodiments of the present application, the beam of the PDSCH will be determined based on whether the UE is configured with “dl-OrJoint-TCIStateList-r17” in some conditions, while the beam of the PDCCH will be as the same as the beam used for the PRACH transmission in some other conditions e.g., as the same as the SSB resource or CSI-RS resource used for the PRACH transmission.

For example, according to some embodiments of the present application, the QCL properties of DMRS ports of the PDSCH will be determined based on whether a parameter as “dl-OrJoint-TCIStateList-r17” is configured in the case that:
a) two values of CORESET pool index are configured for CORESETs in the BWP of the serving cell, two TAGs are configured in the serving cell, at least one activated joint or downlink TCI state is associated with an additional PCI and the PRACH resource is associated with the additional PCI; or
b) two values of CORESET pool index are configured for CORESETs in the BWP of the serving cell, two TAGs are configured in the serving cell, and the PRACH resource is associated with a value of CORESET pool index different from that of a CORESET where the PDCCH is received; or
c) L1/L2-triggered mobility is configured in the serving cell and the PRACH resource is associated with an additional PCI or a candidate cell; or
d) two values of CORESET pool index are configured for CORESETs in the BWP of the serving cell, two TAGs are configured in the serving cell, at least one activated joint or downlink TCI state is associated with an additional PCI, only one type 1 CSS associated with a CORESET which is associated with a PCI of the serving cell is configured, and the PRACH resource is associated with the additional PCI.

According to some embodiments of the present application, the DMRS ports of the PDSCH will be determined to be QCL with an SSB resource or CSI-RS resource used for transmitting the PRACH resource, in response to that:
a) two values of CORESET pool index are configured for CORESETs in the BWP of the serving cell, two TAGs are configured in the serving cell, at least one activated joint or downlink TCI state is associated with an additional PCI, and the PRACH resource is associated with a PCI of the serving cell; or
b) two values of CORESET pool index are configured for CORESETs in the BWP of the serving cell, two TAGs are configured in the serving cell, and the PRACH resource is associated with a value of CORESET pool index of a CORESET where the PDCCH is received; or
c) L1/L2-triggered mobility is configured in the serving cell and the PRACH resource is associated with a PCI of the serving cell; or
d) two values of CORESET pool index are configured for CORESETs in the BWP of the serving cell, two TAGs are configured in the serving cell, at least one activated joint or downlink TCI state is associated with an additional PCI, and an additional type 1 CSS associated with a CORESET which is associated with the additional PCI is configured; or
e) two CORESET pool indexes configured or CORESETs in the BWP of the serving cell, two TAGs are configured in the serving cell, at least one activated joint or downlink TCI state is associated with an additional PCI, only one type 1 CSS associated with a CORESET which is associated with a PCI of the serving cell is configured, and the PRACH resource is associated with the PCI of the serving cell.

Some exemplary cases are illustrated below.

### Cases 2-1

According to some embodiments of the present application, regardless of M-DCI based M-TRP with TA enhancement or L1/L2-triggered mobility, the beam of the PDSCH will always be determined based on whether the UE is configured with “dl-OrJoint-TCIStateList-r17” or the like.

First, it is assumed that the UE is not configured with “dl-OrJoint-TCIStateList-r17” or the like, and the beam of the PDSCH is determined as R15/R16 specification.

According to some embodiments of the present application, in some exemplary scenarios of M-DCI based M-TRP with TA enhancement, in the case that the time offset between the reception of the PDCCH or DCI (e.g., DCI format 1_0 with CRC scrambled by RA-RNTI or MSGB-RNTI) scheduling the PDSCH and the PDSCH is equal to or greater than a threshold, e.g., a threshold based on reported UE capability (e.g., “timeDurationForQCL”), the beam of the PDSCH will be determined as the same as the beam of the CORESET used for the PDCCH transmission. It means that UE may assume that the TCI state or the QCL assumption for the PDSCH is identical to the TCI state or QCL assumption whichever is applied for the CORESET used for the PDCCH transmission within the active BWP of the serving cell.

According to some other embodiments of the present application, in some exemplary scenarios of M-DCI based M-TRP with TA enhancement, e.g., the UE is configured by higher layer parameter “PDCCH-Config” that contains two different values of coresetPoolIndex in “ControlResourceSets” for the BWP of the serving cell, in the case that the offset between the reception of the PDCCH or DCI scheduling the PDSCH and the PDSCH is less than the threshold “timeDurationForQCL,” at least one configured TCI state for the serving cell of the PDSCH contains qel-Type set to ‘typeD’, and the UE is configured with “enableDefaultTCI-StatePerCoresetPoolIndex,” the beam of the PDSCH will be determined as the same as the beam of the CORESET associated with a monitored search space with the lowest CORESET identity among CORESETs which are configured with the same CORESETPoolIndex value of the PDCCH scheduling the PDSCH in the latest slot where one or more CORESETs are associated with the same CORESETPoolIndex value are monitored by the UE. It means that the UE may assume that the DMRS ports of the corresponding PDSCH associated with a value of coresetPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of coresetPoolIndex as the PDCCH scheduling that PDSCH, in the latest slot in which one or more CORESETs associated with the same value of coresetPoolIndex as the PDCCH scheduling that PDSCH within the active BWP of the serving cell are monitored by the UE.

Second, it is assumed that the UE is configured with “dl-OrJoint-TCIStateList-r17” or the like, and the beam of the PDSCH is determined as R17 specification.

According to some embodiments of the present application, in some exemplary scenarios of M-DCI based M-TRP with TA enhancement, e.g., the UE is configured by higher layer parameter “PDCCH-Config” that contains two different values of coresetPoolIndex in “ControlResourceSets” for the BWP of the serving cell, the beam of the PDSCH will be determined, e.g., by the UE to be the joint or downlink TCI state which is applicable in the slot where the PDSCH is transmitted and associated with the same CORESETPoolIndex value of the CORESET where the PDCCH scheduling the PDSCH is received. In addition, the joint or downlink TCI state is indicated by a DCI or a MAC CE which is applicable from a first slot which is determined by R17 specification. It means that the UE may assume that the DMRS ports of the corresponding PDSCH of a serving cell are quasi co-located with the RS(s) in the joint or downlink TCI state which is applicable in the slot where the PDSCH is transmitted and associated with a same CORESETPoolIndex value of the CORESET where the scheduling PDCCH is transmitted with respect to the QCL type parameter(s) given by the joint or downlink TCI state.

According to some other embodiments of the present application, in some exemplary scenarios of L1/L2-triggered mobility, e.g., the UE is configured with L1/L2-triggered mobility, the beam of the PDSCH will be the joint or downlink TCI state which is applicable in the slot where the PDSCH is transmitted. It means that the UE may assume that the DMRS ports of the corresponding PDSCH of a serving cell are quasi co-located with the RS(s) in the joint or DL TCI state with respect to the QCL type parameter(s) given by the joint or DL TCI state.

### Cases 2-2

In some embodiments of the present application, the beam of the PDCCH is the same as the beam used for the PRACH transmission in some conditions, e.g., as the same as the SSB resource or CSI-RS resource used for the PRACH transmission; while in the case that these conditions are not satisfied, the beam of the PDSCH will be determined based on whether the UE is configured with “dl-OrJoint-TCIStateList-r17” or the like as illustrated in Cases 2-1.

For example, in some exemplary scenarios of inter-cell M-DCI based M-TRP with TA enhancement, e.g., the UE is configured by higher layer parameter “PDCCH-Config” that contains two different values of coresetPoolIndex in “ControlResourceSets” for the BWP of the serving cell, and at least one activated joint or downlink TCI state is associated with an additional PCI, the beam of the PDDCH will be determined as the following.

In the case that the PRACH transmission is associated with the serving cell PCI, the beam of the PDSCH will be as the same as the beam used for the PRACH transmission. It means that the UE may assume that the DMRS ports of the PDSCH are quasi co-located with the SSB resource or the CSI-RS resource that the UE used for the PRACH transmission as applicable, and transmission with respect to Doppler shift, Doppler spread, average delay, delay spread, spatial RX parameters when applicable.

Otherwise, in the case that the PRACH transmission is associated with the additional PCI, the beam of PDSCH will be determined based on whether the UE is configured with “dl-OrJoint-TCIStateList-r17” or the like as illustrated in Cases 2-1.

In some exemplary scenarios of intra-cell M-DCI based M-TRP with TA enhancement, e.g., the UE is configured by higher layer parameter “PDCCH-Config” that contains two different values of coresetPoolIndex in “ControlResourceSets” for the BWP of the serving cell, the beam of the PDDCH will be determined as the following.

In the case that the PRACH transmission is associated with the same CORESETPoolIndex value of a CORESET where the PDCCH is transmitted (or the CORESET is associated with type 1 PDCCH CSS), the beam of the PDSCH will be as the same as the beam used for the PRACH transmission. It means that the UE may assume that the DMRS ports of the PDSCH are quasi co-located with the SSB resource or the CSI-RS resource that the UE used for the PRACH transmission as applicable, and transmission with respect to Doppler shift, Doppler spread, average delay, delay spread, spatial RX parameters when applicable.

Otherwise, in the case that the PRACH transmission is associated with a CORESETPoolIndex value different from that of a CORESET where the scheduling PDCCH is transmitted, that is, the PRACH transmission is not associated with a CORESETPoolIndex value of the CORESET where the scheduling PDCCH is transmitted, the beam of the PDSCH will be determined based on whether the UE is configured with “dl-OrJoint-TCIStateList-r17” or the like as illustrated in Cases 2-1.

In some exemplary scenarios of L1/L2-triggered mobility, e.g., the UE is configured with L1/L2 inter-cell mobility, the beam of the PDDCH will be determined as the following.

In the case that the PRACH transmission is associated with serving cell PCI, the beam of the PDSCH will be as the same as the beam used for the PRACH transmission. It means that the UE may assume that the DMRS ports of the PDSCH will be quasi co-located with the SSB resource or the CSI-RS resource that the UE used for the PRACH transmission as applicable, and transmission with respect to Doppler shift, Doppler spread, average delay, delay spread, spatial RX parameters when applicable.

Otherwise, in the case that associated the PRACH transmission is associated with the additional PCI or a candidate cell, the beam of the PDSCH will be determined based on whether the UE is configured with “dl-OrJoint-TCIStateList-r17” as illustrated in Cases 2-1.

### Cases 2-3

Similar to Cases 2-2, in some other embodiments of the present application, the beam of the PDCCH is the same as the beam used for the PRACH transmission in some conditions, e.g., as the same as the SSB resource or CSI-RS resource used for the PRACH transmission; while in the case that these conditions are not satisfied, the beam of the PDSCH will be determined based on whether the UE is configured with “dl-OrJoint-TCIStateList-r17” or the like. However, Cases 2-3 are only applied in inter-cell M-DCI based M-TRP.

For example, in some exemplary scenarios of inter-cell M-DCI based M-TRP, e.g., the UE is configured by higher layer parameter “PDCCH-Config” that contains two different values of coresetPoolIndex in “ControlResourceSets” for the BWP of the serving cell, and at least one activated joint or downlink TCI state is associated with an additional PCI, the beam of the PDCCH will be determined as the following.

In the case that one additional Type 1 CSS associated with a CORESET which is associated with an additional PCI is configured, the beam of the PDSCH will be determined as the same as the beam used for the PRACH transmission. It means that the UE may assume that the DMRS port of the PDSCH is quasi co-located with the SSB resource or the CSI-RS resource that the UE used for the PRACH transmission as applicable, and transmission with respect to Doppler shift, Doppler spread, average delay, delay spread, spatial RX parameters when applicable.

Otherwise, in the case that only one type 1 CSS associated with a CORESET which is associated with a PCI of the serving cell is configured and the PRACH transmission is associated with the serving cell PCI, the beam of the PDSCH will be as the same as the beam used for the PRACH transmission. It means that the UE may assume that the DMRS port of the PDSCH is quasi co-located with the SSB resource or the CSI-RS resource the UE used for the PRACH transmission as applicable, and transmission with respect to Doppler shift, Doppler spread, average delay, delay spread, spatial RX parameters when applicable. In the case that only one type 1 CSS associated with a CORESET which is associated with a PCI of the serving cell is configured and the PRACH transmission is associated with the additional PCI, the beam of PDSCH will also be determined based on whether the UE is configured with “dl-OrJoint-TCIStateList-r17” or the like as illustrated in Cases 2-1.

### Beam of PDCCH Order

According to some embodiments of the present application, a PDCCH order which triggers a CRFA procedure for the SpCell is in DCI format 1_0 with CRC scrambled by C-RNTI.

Regarding the beam determination of the PDCCH order, in some embodiments of the present application, the beam of the PDCCH order is always as the same as the beam of the CORESET where the PDCCH order is transmitted (or received). In some other embodiments of the present application, the beam of the PDCCH order is the same as the beam of the CORESET where the PDCCH order is transmitted (or received) in some conditions, while is the same as the beam used for the PRACH transmission in some other conditions, e.g., as the same as the SSB resource or CSI-RS resource used for the PRACH transmission.

For example, in some embodiments of the present application, the DMRS port of the PDCCH order is determined to be QCL with at least one RS of a TCI state of a CORESET where the PDCCH order is transmitted in response to that:
a) two values of CORESET pool index are configured for CORESETs in the BWP of the serving cell, and two TAGs are configured in the serving cell; or
b) L1/L2-triggered mobility is configured in the serving cell; or
c) L1/L2-triggered mobility is configured in the serving cell and the PRACH resource is associated with an additional PCI or a candidate cell.

In some embodiments of the present application, the DMRS port of the PDCCH order is determined to be QCL with an SSB resource or CSI-RS resource used for transmitting the PRACH resource in response to that L1/L2-triggered mobility is configured in the serving cell and the PRACH resource is associated with a PCI of the serving cell.

Some exemplary cases are illustrated below.

### Cases 3-1

According to some embodiments of the present application, regardless of in M-DCI based M-TRP with TA enhancement or L1/L2-triggered mobility scenarios, the beam of the PDCCH order is always determined as the same as the beam of the CORESET where the PDCCH order is transmitted (or received). It means that the UE may assume the DMRS antenna port of the PDCCH order quasi co-location properties of the CORESET where the PDCCH order is transmitted (or received).

### Cases 3-2

In some other embodiments of the present application, e.g., L1/L2-triggered mobility, the beam of the PDCCH order is the same as the beam of the CORESET where the PDCCH is transmitted in some conditions, while is the same as the beam used for the PRACH transmission in some other conditions, e.g., as the same as the SSB resource or CSI-RS resource used for the PRACH transmission, which depends on different specific configurations of the UE.

For example, in some exemplary scenarios of L1/L2-triggered mobility, e.g., the UE is configured with L1/L2-triggered mobility, the beam of the PDCCH order will be determined as the following. In the case that the PRACH transmission triggered by the PDCCH order is associated with serving cell PCI, the beam of the PDCCH order will be as the same as the beam used for the PRACH transmission. It means that the UE may assume that the DMRS port of the PDCCH order is quasi co-located with the SSB resource or the CSI-RS resource that the UE used for the PRACH transmission as applicable, and transmission with respect to Doppler shift, Doppler spread, average delay, delay spread, spatial RX parameters when applicable. Otherwise, in the case that the PRACH transmission triggered by the PDCCH order is associated with an additional PCI, the beam of the PDCCH order will be determined as the same as the beam of the CORESET where the PDCCH order is transmitted or received.

Besides the methods, embodiments of the present application also propose an apparatus of beam determination.

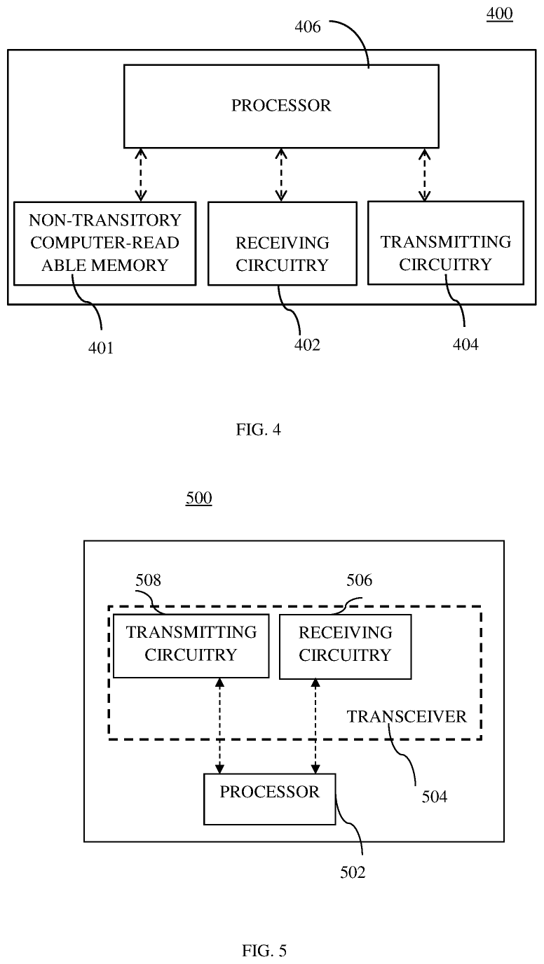

For example, FIG. 4 illustrates a block diagram of an apparatus of beam determination 400 according to some embodiments of the present application.

As shown in FIG. 4, the apparatus 400 may include at least one non-transitory computer-readable medium 401, at least one receiving circuitry 402, at least one transmitting circuitry 404, and at least one processor 406 coupled to the non-transitory computer-readable medium 401, the receiving circuitry 402 and the transmitting circuitry 404. The at least one processor 406 may be a central processing unit (CPU), a digital signaling processing (DSP), a microprocessor etc. The apparatus 400 may be a RAN node, e.g., a gNB or a remote apparatus, e.g., a UE configured to perform a method illustrated in the above or the like.

Although in this figure, elements such as the at least one processor 406, transmitting circuitry 404, and receiving circuitry 402 are described in the singular, the plural is contemplated unless a limitation to the singular is explicitly stated. In some embodiments of the present application, the receiving circuitry 402 and the transmitting circuitry 404 can be combined into a single device, such as a transceiver. In certain embodiments of the present application, the apparatus 400 may further include an input device, a memory, and/or other components.

In some embodiments of the present application, the non-transitory computer-readable medium 401 may have stored thereon computer-executable instructions to cause a processor to implement the method with respect to the RAN node, e.g., the gNB as described above. For example, the computer-executable instructions, when executed, cause the processor 406 interacting with receiving circuitry 402 and transmitting circuitry 404, so as to perform the steps with respect to the RAN node as depicted above.

In some embodiments of the present application, the non-transitory computer-readable medium 401 may have stored thereon computer-executable instructions to cause a processor to implement the method with respect to the remote apparatus, e.g., the UE as described above. For example, the computer-executable instructions, when executed, cause the processor 406 interacting with receiving circuitry 402 and transmitting circuitry 404, so as to perform the steps with respect to the remote apparatus as illustrated above.

FIG. 5 is a block diagram of an apparatus of beam determination 500 according to some other embodiments of the present application.

Referring to FIG. 5, the apparatus 500, for example a RAN node or a UE may include at least one processor 502 and at least one transceiver 504 coupled to the at least one processor 502. The transceiver 504 may include at least one separate receiving circuitry 506 and transmitting circuitry 504, or at least one integrated receiving circuitry 506 and transmitting circuitry 504. The at least one processor 502 may be a CPU, a DSP, a microprocessor etc.

According to some embodiments of the present application, the apparatus 500 is a RAN node, e.g., a gNB, which includes: a transceiver; and a processor coupled to the transceiver, wherein the processor is configured to: receive a PRACH resource in a BWP of a serving cell; determine QCL properties of DMRS port of a PDCCH in response to the PRACH resource at least based on whether a plurality of values of CORESET pool index are configured for CORESETs in the BWP of the serving cell and a plurality of TAGs are configured in the serving cell, or whether L1/L2-triggered mobility is configured in the serving cell; and transmit the PDCCH based on the determined QCL properties of DMRS port of the PDCCH.

According to some embodiments of the present application, the apparatus 500 is a remote apparatus, e.g., a UE, which includes: a transceiver; and a processor coupled to the transceiver, wherein the processor is configured to: transmit a PRACH resource in a BWP of a serving cell; determine QCL properties of DMRS port of a PDCCH in response to the PRACH resource at least based on whether a plurality of values of CORESET pool index are configured for CORESETs in the BWP of the serving cell and a plurality of TAGs are configured in the serving cell, or whether L1/L2-triggered mobility is configured in the serving cell; and receive the PDCCH based on the determined QCL properties of DMRS port of the PDCCH.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as random access memory (RAMs), read only memory (ROMs), flash memory, electrically erasable programmable read only memory (EEPROMs), optical storage devices (compact disc (CD) or digital video disc (DVD)), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A wireless communication apparatus, comprising:
at least one memory; and
at least one processor coupled with the at least one memory and configured to cause the wireless communication apparatus to:
transmit a physical random access channel (PRACH) resource in a bandwidth part (BWP) of a serving cell;
determine quasi co-location (QCL) properties of demodulation reference signal (DMRS) port of a physical downlink control channel (PDCCH) in response to the PRACH resource at least based on whether a plurality of values of control resource set (CORESET) pool index are configured for CORESETs in the BWP of the serving cell and a plurality of timing advance groups (TAGs) are configured in the serving cell; and
receive the PDCCH based on the determined QCL properties of DMRS port of the PDCCH.

2. The wireless communication apparatus of claim 1, wherein determining the QCL properties of DMRS port of the PDCCH comprises:
determining that the DMRS port of the PDCCH is QCL with at least one reference signal (RS) associated with a transmission configuration indication (TCI) state of a CORESET where the PDCCH is received in response to that:
two values of CORESET pool index are configured for CORESETs in the BWP of the serving cell, two TAGs are configured in the serving cell, at least one activated joint or downlink TCI state is associated with an additional physical cell identifier (PCI) and the PRACH resource is associated with the additional PCI.

3. The wireless communication apparatus of claim 1, wherein determining the QCL properties of DMRS port of the PDCCH comprises:
determining that the DMRS port of the PDCCH is QCL with a synchronization signal (SS)/physical broadcast channel (PBCH) block (SSB) resource or channel state information (CSI)-reference signal (RS) resource used for transmitting the PRACH resource, in response to that:
two values of CORESET pool index are configured for CORESETs in the BWP of the serving cell, two TAGs are configured in the serving cell, at least one activated joint or downlink transmission configuration indication (TCI) state is associated with an additional physical cell identifier (PCI) and the PRACH resource is associated with a PCI of the serving cell; or
L1/L2-triggered mobility is configured in the serving cell and the PRACH resource is associated with the PCI of the serving cell; or
two values of CORESET pool index are configured for CORESETs in the BWP of the serving cell, two TAGs are configured in the serving cell, and the PRACH resource is associated with a value of CORESET pool index of a CORESET where the PDCCH is received; or
two values of CORESET pool indexes in different CORESETs are configured for CORESETs in the BWP of the serving cell, two TAGs are configured in the serving cell, at least one activated joint or downlink TCI state is associated with an additional PCI and one additional type 1 common search space (CSS) associated with a CORESET which is associated with the additional PCI is configured; or
two CORESET pool indexes configured for CORESETs in the BWP of the serving cell, two TAGs are configured in the serving cell, at least one activated joint or downlink TCI state is associated with an additional PCI, only one type 1 CSS associated with a CORESET which is associated with a PCI of the serving cell is configured, and the PRACH resource is associated with the PCI of the serving cell.

4. The wireless communication apparatus of claim 1, wherein the at least one processor is configured to cause the wireless communication apparatus to determine QCL properties of DMRS ports of a physical downlink shared channel (PDSCH) scheduled by the PDCCH, comprising:
determining the QCL properties of DMRS ports of the PDSCH based on whether a parameter as “dl-OrJoint-TCIStateList-r17” is configured, wherein:
in response to the parameter as “dl-OrJoint-TCIStateList-r17” not being configured, two values of CORESET pool index are configured for CORESETs in the BWP of the serving cell, and two TAGs are configured in the serving cell, determining that the DMRS ports of the PDSCH are QCL with:
at least one reference signal (RS) associated with a transmission configuration indication (TCI) state of a CORESET where the PDCCH is received, in response to that a time offset between reception of the PDCCH and the PDSCH is equal to or greater than a threshold; or
at least one RS associated with a TCI state of a CORESET associated with a monitored search space with a lowest CORESET identity among CORESETs which are configured with a same value of CORESET pool index of the PDCCH in a latest slot where one or more CORESETs associated with the same value of CORESET pool index are monitored in response to that the time offset between reception of the PDCCH and the PDSCH is less than the threshold, at least one configured TCI state for the serving cell of the PDSCH contains a parameter as “qcl-Type” set to ‘typeD’ and a parameter as “enableDefaultTCI-StatePerCoresetPoolIndex” is configured; or
in response to the parameter as “dl-OrJoint-TCIStateList-r17” being configured, two values of CORESET pool index are configured for CORESETs in the BWP of the serving cell, and two TAGs are configured in the serving cell, determining that the DMRS ports of the PDSCH are QCL with:
at least one RS associated with a joint or downlink TCI state which is applicable in a slot where the PDSCH is received and associated with a same CORESET pool index of a CORESET where the PDCCH is received; or
in response to the parameter “dl-OrJoint-TCIStateList-r17” being configured, and L1/L2-triggered mobility is configured in the serving cell, determining that the DMRS ports of the PDSCH are QCL with:
at least one RS associated with a joint or downlink TCI state which is applicable in a slot where the PDSCH is received.

5. The wireless communication apparatus of claim 4, wherein the at least one processor is configured to cause the wireless communication apparatus to determine the QCL properties of DMRS ports of the PDSCH based on whether a parameter as “dl-OrJoint-TCIStateList-r17” is configured in response to:
two values of CORESET pool index are configured for CORESETs in the BWP of the serving cell, two TAGs are configured in the serving cell, at least one activated joint or downlink TCI state is associated with an additional physical cell identifier (PCI) and the PRACH resource is associated with the additional PCI; or
two values of CORESET pool index are configured for CORESETs in the BWP of the serving cell, two TAGs are configured in the serving cell, and the PRACH resource is associated with a value of CORESET pool index different from that of a CORESET where the PDCCH is received; or
L1/L2-triggered mobility is configured in the serving cell and the PRACH resource is associated with an additional PCI or a candidate cell; or
two values of CORESET pool index are configured for CORESETs in the BWP of the serving cell, two TAGs are configured in the serving cell, at least one activated joint or downlink TCI state is associated with an additional PCI, only one type 1 common search space (CSS) associated with a CORESET which is associated with a PCI of the serving cell is configured, and the PRACH resource is associated with the additional PCI.

6. The wireless communication apparatus of claim 1, wherein the at least one processor is configured to cause the wireless communication apparatus to determine QCL properties of DMRS ports of a physical downlink shared channel (PDSCH) scheduled by the PDCCH, comprising:
determining that the DMRS ports of the PDSCH are QCL with a synchronization signal (SS)/physical broadcast channel (PBCH) block (SSB) resource or channel state information (CSI)-reference signal (RS) resource used for transmitting the PRACH resource, in response to that:
two values of CORESET pool index are configured for CORESETs in the BWP of the serving cell, two TAGs are configured in the serving cell, at least one activated joint or downlink transmission configuration indication (TCI) state is associated with an additional physical cell identifier (PCI), and the PRACH resource is associated with a PCI of the serving cell; or
two values of CORESET pool index are configured for CORESETs in the BWP of the serving cell, two TAGs are configured in the serving cell, and the PRACH resource is associated with a value of CORESET pool index of a CORESET where the PDCCH is received; or
L1/L2-triggered mobility is configured in the serving cell and the PRACH resource is associated with a PCI of the serving cell; or
two values of CORESET pool index are configured for CORESETs in the BWP of the serving cell, two TAGs are configured in the serving cell, at least one activated joint or downlink TCI state is associated with an additional PCI, and an additional type 1 common search space (CSS) associated with a CORESET which is associated with the additional PCI is configured; or
two CORESET pool indexes configured for CORESETs in the BWP of the serving cell, two TAGs are configured in the serving cell, at least one activated joint or downlink TCI state is associated with an additional PCI, only one type 1 CSS associated with a CORESET which is associated with a PCI of the serving cell is configured, and the PRACH resource is associated with the PCI of the serving cell.

7. The wireless communication apparatus of claim 1, wherein transmission of the PRACH resource is initiated by a PDCCH order and the at least one processor is configured to cause the wireless communication apparatus to determine QCL properties of DMRS port of the PDCCH order, comprising:
determining that the DMRS port of the PDCCH order is QCL with at least one reference signal (RS) of a transmission configuration indication (TCI) state of a CORESET where the PDCCH order is transmitted in response to that two values of CORESET pool index are configured for CORESETs in the BWP of the serving cell, and two TAGs are configured in the serving cell; or L1/L2-triggered mobility is configured in the serving cell; or L1/L2-triggered mobility is configured in the serving cell and the PRACH resource is associated with an additional physical cell identifier (PCI) or a candidate cell; or
determining that the DMRS port of the PDCCH order is QCL with a synchronization signal (SS)/physical broadcast channel (PBCH) block (SSB) resource or channel state information (CSI)-RS resource used for transmitting the PRACH resource in response to that L1/L2-triggered mobility is configured in the serving cell and the PRACH resource is associated with a PCI of the serving cell.

8. A wireless communication apparatus, comprising:
at least one memory; and
at least one processor coupled with the at least one memory and configured to cause the wireless communication apparatus to:
receive a physical random access channel (PRACH) resource in a bandwidth part (BWP) of a serving cell;
determine quasi co-location (QCL) properties of demodulation reference signal (DMRS) port of a physical downlink control channel (PDCCH) in response to the PRACH resource at least based on whether a plurality of values of control resource set (CORESET) pool index are configured for CORESETs in the BWP of the serving cell and a plurality of timing advance groups (TAGs) are configured in the serving cell; and
transmit the PDCCH based on the determined QCL properties of DMRS port of the PDCCH.

9. The wireless communication apparatus of claim 8, wherein
determining the QCL properties of DMRS port of the PDCCH comprises:
determining that the DMRS port of the PDCCH is QCL with at least one reference signal (RS) associated with a transmission configuration indication (TCI) state of a CORESET where the PDCCH is transmitted in response to that:
two values of CORESET pool index are configured for CORESETs in the BWP of the serving cell, two TAGs are configured in the serving cell, at least one activated joint or downlink TCI state is associated with an additional physical cell identifier (PCI) and the PRACH resource is associated with the additional PCI.

10. The wireless communication apparatus of claim 8, wherein
determining the QCL properties of DMRS port of the PDCCH comprises:
determining that the DMRS port of the PDCCH is QCL with a synchronization signal (SS)/physical broadcast channel (PBCH) block (SSB) resource or channel state information (CSI)-reference signal (RS) resource used for receiving the PRACH resource, in response to that:
two values of CORESET pool index are configured for CORESETs in the BWP of the serving cell, two TAGs are configured in the serving cell, at least one activated joint or downlink transmission configuration indication (TCI) state is associated with an additional physical cell identifier (PCI) and the PRACH resource is associated with a PCI of the serving cell; or
L1/L2-triggered mobility is configured in the serving cell and the PRACH resource is associated with the PCI of the serving cell; or
two values of CORESET pool index are configured for CORESETs in the BWP of the serving cell, two TAGs are configured in the serving cell, and the PRACH resource is associated with a value of CORESET pool index of a CORESET where the PDCCH is transmitted; or
two values of CORESET pool indexes in different CORESETs are configured for CORESETs in the BWP of the serving cell, two TAGs are configured in the serving cell, at least one activated joint or downlink TCI state is associated with an additional PCI and one additional type 1 common search space (CSS) associated with a CORESET which is associated with the additional PCI is configured; or
two values of CORESET pool index are configured for CORESETs in the BWP of the serving cell, two TAGs are configured in the serving cell, at least one activated joint or downlink TCI state is associated with an additional PCI, only one type 1 common search space (CSS) associated with a CORESET which is associated with a PCI of the serving cell is configured, and the PRACH resource is associated with the PCI of the serving cell.

48. The wireless communication apparatus of claim 8, wherein the at least one processor is configured to cause the wireless communication apparatus to determine QCL properties of DMRS ports of a physical downlink shared channel (PDSCH) scheduled by the PDCCH, comprising:
determining the QCL properties of DMRS ports of the PDSCH based on whether a parameter as “dl-OrJoint-TCIStateList-r17” is configured, wherein:
in response to the parameter as “dl-OrJoint-TCIStateList-r17” not being configured, two values of CORESET pool index are configured for CORESETs in the BWP of the serving cell, and two TAGs are configured in the serving cell, determining that the DMRS ports of the PDSCH are QCL with:
at least one reference signal (RS) associated with a transmission configuration indication (TCI) state of a CORESET where the PDCCH is transmitted, in response to that a time offset between transmission of the PDCCH and the PDSCH is equal to or greater than a threshold; or
at least one RS associated with a TCI state of a CORESET associated with a monitored search space with a lowest CORESET identity among CORESETs which are configured with a same value of CORESET pool index of the PDCCH in a latest slot where one or more CORESETs associated with the same value of CORESET pool index are monitored in response to that the time offset between transmission of the PDCCH and the PDSCH is less than the threshold, at least one configured TCI state for the serving cell of the PDSCH contains a parameter as “qcl-Type” set to ‘typeD’ and a parameter as “enableDefaultTCI-StatePerCoresetPoolIndex” is configured; or
in response to the parameter as “dl-OrJoint-TCIStateList-r17” being configured, two values of CORESET pool index are configured for CORESETs in the BWP of the serving cell, and two TAGs are configured in the serving cell, determining that the DMRS ports of the PDSCH are QCL with:
at least one RS associated with a joint or downlink TCI state which is applicable in a slot where the PDSCH is transmitted and associated with a same CORESET pool index of a CORESET where the PDCCH is transmitted; or
in response to the parameter as “dl-OrJoint-TCIStateList-r17” being configured, and L1/L2-triggered mobility is configured in the serving cell, determining that the DMRS ports of the PDSCH are QCL with:
at least one RS associated with a joint or downlink TCI state which is applicable in a slot where the PDSCH is transmitted.

12. The wireless communication apparatus of claim 11, wherein the at least one processor is configured to cause the wireless communication apparatus to determine the QCL properties of DMRS ports of the PDSCH based on whether a parameter as “dl-OrJoint-TCIStateList-r17” is configured in response to:
two values of CORESET pool index are configured for CORESETs in the BWP of the serving cell, two TAGs are configured in the serving cell, at least one activated joint or downlink TCI state is associated with an additional physical cell identifier (PCI) and the PRACH resource is associated with the additional PCI; or
two values of CORESET pool index are configured for CORESETs in the BWP of the serving cell, two TAGs are configured in the serving cell, and the PRACH resource is associated with a value of CORESET pool index different from that of a CORESET where the PDCCH is transmitted; or
L1/L2-triggered mobility is configured in the serving cell and the PRACH resource is associated with an additional PCI or a candidate cell; or
two values of CORESET pool index are configured for CORESETs in the BWP of the serving cell, two TAGs are configured in the serving cell, at least one activated joint or downlink TCI state is associated with an additional PCI, only one type 1 common search space (CSS) associated with a CORESET which is associated with a PCI of the serving cell is configured, and the PRACH resource is associated with the additional PCI.

13. The wireless communication apparatus of claim 8, wherein the at least one processor is configured to cause the wireless communication apparatus to determine QCL properties of DMRS ports of a physical downlink shared channel (PDSCH) scheduled by the PDCCH, comprising:
determining that the DMRS ports of the PDSCH are QCL with a synchronization signal (SS)/physical broadcast channel (PBCH) block (SSB) resource or channel state information (CSI)-reference signal (RS) resource used for receiving the PRACH resource, in response to that:
two values of CORESET pool index are configured for CORESETs in the BWP of the serving cell, two TAGs are configured in the serving cell, at least one activated joint or downlink transmission configuration indication (TCI) state is associated with an additional physical cell identifier (PCI), and the PRACH resource is associated with a PCI of the serving cell; or
two values of CORESET pool index are configured for CORESETs in the BWP of the serving cell, two TAGs are configured in the serving cell, and the PRACH resource is associated with a value of CORESET pool index of a CORESET where the PDCCH is transmitted; or
L1/L2-triggered mobility is configured in the serving cell and the PRACH resource is associated with a PCI of the serving cell; or
two values of CORESET pool index are configured for CORESETs in the BWP of the serving cell, two TAGs are configured in the serving cell, at least one activated joint or downlink TCI state is associated with an additional PCI, and an additional type 1 common search space (CSS) associated with a CORESET which is associated with the additional PCI is configured; or
two CORESET pool indexes configured for CORESETs in the BWP of the serving cell, two TAGs are configured in the serving cell, at least one activated joint or downlink TCI state is associated with an additional PCI, only one type 1 CSS associated with a CORESET which is associated with a PCI of the serving cell is configured, and the PRACH resource is associated with the PCI of the serving cell.

14. The wireless communication apparatus of claim 8, wherein transmission of the PRACH resource is initiated by a PDCCH order and the at least one processor is configured to cause the wireless communication apparatus to determine QCL properties of DMRS port of the PDCCH order, comprising:
determining that the DMRS port of the PDCCH order is QCL with at least one reference signal (RS) of a transmission configuration indication (TCI) state of a CORESET where the PDCCH order is transmitted in response to that two values of CORESET pool index are configured for CORESETs in the BWP of the serving cell, and two TAGs are configured in the serving cell; or L1/L2-triggered mobility is configured in the serving cell; or L1/L2-triggered mobility is configured in the serving cell and the PRACH resource is associated with an additional physical cell identifier (PCI) or a candidate cell; or
determining that the DMRS port of the PDCCH order is QCL with a synchronization signal (SS)/physical broadcast channel (PBCH) block (SSB) resource or channel state information (CSI)-RS resource used for receiving the PRACH resource in response to that L1/L2-triggered mobility is configured in the serving cell and the PRACH resource is associated with a PCI of the serving cell.

15. A wireless communication method, the method comprising:
receiving a physical random access channel (PRACH) resource in a bandwidth part (BWP) of a serving cell;
determining quasi co-location (QCL) properties of demodulation reference signal (DMRS) port of a physical downlink control channel (PDCCH) in response to the PRACH resource at least based on whether a plurality of values of control resource set (CORESET) pool index are configured for CORESETs in the BWP of the serving cell and a plurality of timing advance groups (TAGs) are configured in the serving cell; and
transmitting the PDCCH based on the determined QCL properties of DMRS port of the PDCCH.

16. A processor for wireless communication, comprising:
at least one controller coupled with at least one memory and configured to cause the processor to:
transmit a physical random access channel (PRACH) resource in a bandwidth part (BWP) of a serving cell;
determine quasi co-location (QCL) properties of demodulation reference signal (DMRS) port of a physical downlink control channel (PDCCH) in response to the PRACH resource at least based on whether a plurality of values of control resource set (CORESET) pool index are configured for CORESETs in the BWP of the serving cell and a plurality of timing advance groups (TAGs) are configured in the serving cell; and
recieve the PDCCH based on the determined QCL properties of DMRS port of the PDCCH.

17. The processor of claim 16, wherein determining the QCL properties of DMRS port of the PDCCH comprises:
determining that the DMRS port of the PDCCH is QCL with at least one reference signal (RS) associated with a transmission configuration indication (TCI) state of a CORESET where the PDCCH is received in response to that:
two values of CORESET pool index are configured for CORESETs in the BWP of the serving cell, two TAGs are configured in the serving cell, at least one activated joint or downlink TCI state is associated with an additional physical cell identifier (PCI) and the PRACH resource is associated with the additional PCI.

18. The processor of claim 16, wherein determining the QCL properties of DMRS port of the PDCCH comprises:
determining that the DMRS port of the PDCCH is QCL with a synchronization signal (SS)/physical broadcast channel (PBCH) block (SSB) resource or channel state information (CSI)-reference signal (RS) resource used for transmitting the PRACH resource, in response to that:
two values of CORESET pool index are configured for CORESETs in the BWP of the serving cell, two TAGs are configured in the serving cell, at least one activated joint or downlink transmission configuration indication (TCI) state is associated with an additional physical cell identifier (PCI) and the PRACH resource is associated with a PCI of the serving cell; or
L1/L2-triggered mobility is configured in the serving cell and the PRACH resource is associated with the PCI of the serving cell; or
two values of CORESET pool index are configured for CORESETs in the BWP of the serving cell, two TAGs are configured in the serving cell, and the PRACH resource is associated with a value of CORESET pool index of a CORESET where the PDCCH is received; or
two values of CORESET pool indexes in different CORESETs are configured for CORESETs in the BWP of the serving cell, two TAGs are configured in the serving cell, at least one activated joint or downlink TCI state is associated with an additional PCI and one additional type 1 common search space (CSS) associated with a CORESET which is associated with the additional PCI is configured; or
two CORESET pool indexes configured for CORESETs in the BWP of the serving cell, two TAGs are configured in the serving cell, at least one activated joint or downlink TCI state is associated with an additional PCI, only one type 1 CSS associated with a CORESET which is associated with a PCI of the serving cell is configured, and the PRACH resource is associated with the PCI of the serving cell.

19. The processor of claim 16, wherein the at least one controller is configured to cause the processor to determine QCL properties of DMRS ports of a physical downlink shared channel (PDSCH) scheduled by the PDCCH, comprising:
determining the QCL properties of DMRS ports of the PDSCH based on whether a parameter as “dl-OrJoint-TCIStateList-r17” is configured, wherein:
in response to the parameter as “dl-OrJoint-TCIStateList-r17” not being configured, two values of CORESET pool index are configured for CORESETs in the BWP of the serving cell, and two TAGs are configured in the serving cell, determining that the DMRS ports of the PDSCH are QCL with:
at least one reference signal (RS) associated with a transmission configuration indication (TCI) state of a CORESET where the PDCCH is received, in response to that a time offset between reception of the PDCCH and the PDSCH is equal to or greater than a threshold; or
at least one RS associated with a TCI state of a CORESET associated with a monitored search space with a lowest CORESET identity among CORESETs which are configured with a same value of CORESET pool index of the PDCCH in a latest slot where one or more CORESETs associated with the same value of CORESET pool index are monitored in response to that the time offset between reception of the PDCCH and the PDSCH is less than the threshold, at least one configured TCI state for the serving cell of the PDSCH contains a parameter as “qcl-Type” set to ‘typeD’ and a parameter as “enableDefaultTCI-StatePerCoresetPoolIndex” is configured; or
in response to the parameter as “dl-OrJoint-TCIStateList-r17” being configured, two values of CORESET pool index are configured for CORESETs in the BWP of the serving cell, and two TAGs are configured in the serving cell, determining that the DMRS ports of the PDSCH are QCL with:
at least one RS associated with a joint or downlink TCI state which is applicable in a slot where the PDSCH is received and associated with a same CORESET pool index of a CORESET where the PDCCH is received; or
in response to the parameter “dl-OrJoint-TCIStateList-r17” being configured, and L1/L2-triggered mobility is configured in the serving cell, determining that the DMRS ports of the PDSCH are QCL with:
at least one RS associated with a joint or downlink TCI state which is applicable in a slot where the PDSCH is received.

20. The processor of claim 19, wherein the at least one controller is configured to cause the processor to determine the QCL properties of DMRS ports of the PDSCH based on whether a parameter as “dl-OrJoint-TCIStateList-r17” is configured in response to:
two values of CORESET pool index are configured for CORESETs in the BWP of the serving cell, two TAGs are configured in the serving cell, at least one activated joint or downlink TCI state is associated with an additional physical cell identifier (PCI) and the PRACH resource is associated with the additional PCI; or
two values of CORESET pool index are configured for CORESETs in the BWP of the serving cell, two TAGs are configured in the serving cell, and the PRACH resource is associated with a value of CORESET pool index different from that of a CORESET where the PDCCH is received; or
L1/L2-triggered mobility is configured in the serving cell and the PRACH resource is associated with an additional PCI or a candidate cell; or
two values of CORESET pool index are configured for CORESETs in the BWP of the serving cell, two TAGs are configured in the serving cell, at least one activated joint or downlink TCI state is associated with an additional PCI, only one type 1 common search space (CSS) associated with a CORESET which is associated with a PCI of the serving cell is configured, and the PRACH resource is associated with the additional PCI.
